(19) United States
(12) Patent Application Publication
(10) Pub. No.: US 2002/0184290 A1
(43) Pub. Date: Dec. 5, 2002

(54) Run queue optimization with hardware multithreading for affinity

(75) Inventors: Bret Ronald Olszewski, austin, TX (US); Lilian R. Romero, Austin, TX (US); Mysore Sathyanarayana Srinivas, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/870,609

(22) Filed: May 31, 2001

(51) Int. Cl. G06F 9/00

(52) U.S. Cl. 709/102

(57) ABSTRACT

A mechanism is invoked when a run queue is looking for a thread to dispatch and there is not a thread currently available. The mechanism checks to see if another logical processor on the same physical processor is running a thread. If another logical processor on the same physical processor is running a thread, the logical processor reduces its priority, allowing the other active processor to consume all of the resources for the physical processor. The hardware contains a timer which periodically wakes up the low priority logical thread. Thus, when a thread becomes ready to dispatch, the logical processor can raise its priority and run a thread.

### BACKGROUND OF THE INVENTION

1. Technical Field

The present invention relates to multiprocessing systems and, in particular, to multithreading on multiprocessing systems. Still more particularly, the present invention provides a method, apparatus, and program for allowing an operating system to dynamically increase and decrease the active number of run queues on the hardware without changing the multiprogramming level.

2. Description of Related Art

In a symmetric multiprocessing (SMP) operating system, multiple central processor units are active at the same time. Certain types of applications involving independent threads or processes of execution lend themselves to multiprocessing. For example, in an order processing system, each order may be entered independently of the other orders. When running workloads, a number of variables influence the total throughput of the system. One variable is the distribution of memory between threads of execution and memory available. Another variable is the affinity of threads to processors (dispatching). Normally, optimal performance is obtained by having the maximum number of threads running to achieve 100% central processor unit (CPU) utilization and to have high affinity.

Hardware multithreading (HMT) allows two or more logical contexts, also referred to as logical processors, to exist on each physical processor. HMT allows each physical processor to alternate between multiple threads, thus increasing the number of threads that are currently running. When a thread is dispatched to a logical processor, the thread runs as if it is the only thread running on the physical processor. However, the physical processor is actually able to run one thread for each logical processor. For example, a system with twenty-four physical processors and two logical processors per physical processors actually functions as a system with forty-eight processors. Current implementations of HMT usually involve sharing of some resources between the logical processors on the physical processor. The benefit is that when one logical processor is waiting for something, such as with memory latency, the other logical processor can perform processing functions.

Another variant of multithreading is called simultaneous multithreading (SMT). In SMT, the resources of the physical processor are shared but the threads actually execute concurrently. For example, one thread may perform a “load” from memory at the same time another thread performs a “multiply”. The number of program threads that are ready to run at any point in time is referred to as the multiprogramming level. Even with HMT, the switch back and forth between logical processors is rapid enough to give software the impression that the multiprogramming level is increased to the number of logical processors per physical processor.

However, the gain in throughput by adding logical processors may be much less than the increase that would be expected by adding a corresponding number of physical processors. In fact, for a system with two logical processors per physical processor, throughput may only increase on the order of ten percent.

In Advanced Interactive eXecutive (AIX), International Business Machine's version of UNIX, the processor management system implements HMT with one run queue for each logical processor. A run queue is a place where ready threads wait to run. When a logical processor becomes idle and there are no threads waiting in the run queue, the processor checks for threads to “steal,” or acquire from another logical processor's run queue. This stealing process allows the system to balance utilization of the various run queues. However, moving a thread between physical processors is expensive, particularly with respect to cache resources.

The AIX implementation of HMT increases the number of run queues to the number of logical processors. Thus, the system tends to have fewer threads with HMT per run queue than without HMT, unless the multiprogramming level is increased. If the multiprogramming level is increased, the amount of memory consumed by threads increases, reducing the amount of memory left for caching data. Thus, the increased number of threads increases the working set, which tends to increase costly cache misses. In other words, the cache is only so big; therefore, increasing the number of threads in a running state at any one time increases the likelihood that data will not be found in the cache. Therefore, increasing the multiprogramming level hurts performance. Furthermore, an imbalance in the number of processes on run queues results in processes jumping around on physical processors, which causes worse cache behavior.

Therefore, it would be advantageous to provide a mechanism for allowing an operating system to dynamically increase and decrease the active number of run queues on the hardware without changing the multiprogramming level. SUMMARY OF THE INVENTION

The present invention takes advantage of the fact that two or more logical processors may exist on one physical processor. A mechanism is invoked when a run queue is looking for a thread to dispatch and there is not a thread currently available for that logical processor. The mechanism checks to see if another logical processor on the same physical processor is running a thread. If another logical processor on the same physical processor is running a thread, the logical processor reduces its priority, allowing the other active logical processor to consume all of the resources of the physical processor. The hardware may have a “fairness” mechanisms to ensure that a low priority logical processor is not “starved” of CPU time forever. The hardware contains a timer which will periodically wake up the low priority logical thread. Thus, when a thread becomes ready to dispatch, the logical processor can raise its priority and run a thread. The present invention allows the operating system to dynamically increase and decrease the active number of run queues on the hardware, thus improving the average processor dispatch affinity without changing the multiprogramming level.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of an illustrative embodiment of a data processing system with which the present invention may advantageously be utilized;

FIG. 2 is a block diagram illustrating hardware multithreading in a multiprocessing system in accordance with a preferred embodiment of the present invention; and

FIG. 3 is a flowchart illustrating the operation of a logical processor in a multiprocessing system in accordance with a preferred embodiment of the present invention.

### DETAILED DESCRIPTION OF THE PREFERRED EMBODIMENT

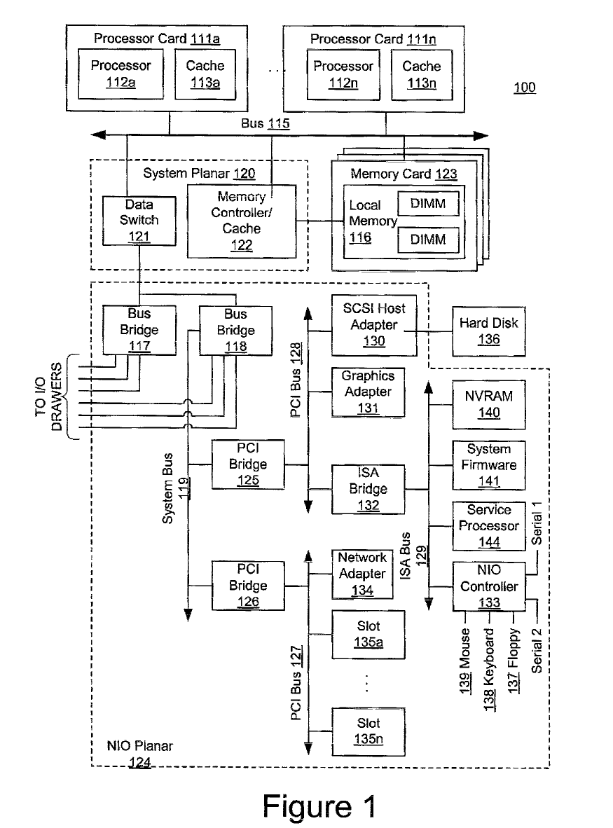

Referring now to the drawings and in particular to FIG. 1, there is depicted a block diagram of an illustrative embodiment of a data processing system with which the present invention may advantageously be utilized. As shown, data processing system 100 includes processor cards 111a-111n. Each of processor cards 111a-111n includes a processor and a cache memory. For example, processor card 111a contains processor 112a and cache memory 113a, and processor card 111n contains processor 112n and cache memory 113n.

Processor cards 111a-111n are connected to main bus 115. Main bus 115 supports a system planar 120 that contains processor cards 111a-111n and memory cards 123. The system planar also contains data switch 121 and memory controller/cache 122. Memory controller/cache 122 supports memory cards 123 that includes local memory 116 having multiple dual in-line memory modules (DIMMs).

Data switch 121 connects to bus bridge 117 and bus bridge 118 located within a native I/O (NIO) planar 124. As shown, bus bridge 118 connects to peripheral components interconnect (PCI) bridges 125 and 126 via system bus 119. PCI bridge 125 connects to a variety of I/O devices via PCI bus 128. As shown, hard disk 136 may be connected to PCI bus 128 via small computer system interface (SCSI) host adapter 130. A graphics adapter 131 may be directly or indirectly connected to PCI bus 128. PCI bridge 126 provides connections for external data streams through network adapter 134 and adapter card slots 135a-135n via PCI bus 127.

An industry standard architecture (ISA) bus 129 connects to PCI bus 128 via ISA bridge 132. ISA bridge 132 provides interconnection capabilities through NIO controller 133 having serial connections Serial 1 and Serial 2. A floppy drive connection 137, keyboard connection 138, and mouse connection 139 are provided by NIO controller 133 to allow data processing system 100 to accept data input from a user via a corresponding input device. In addition, non-volatile RAM (NVRAM) 140 provides a non-volatile memory for preserving certain types of data from system disruptions or system failures, such as power supply problems. A system firmware 141 is also connected to ISA bus 129 for implementing the initial Basic Input/Output System (BIOS) functions. A service processor 144 connects to ISA bus 129 to provide functionality for system diagnostics or system servicing.

The operating system (OS) is stored on hard disk 136, which may also provide storage for additional application software for execution by data processing system. NVRAM 140 is used to store system variables and error information for field replaceable unit (FRU) isolation. During system startup, the bootstrap program loads the operating system and initiates execution of the operating system. To load the operating system, the bootstrap program first locates an operating system kernel type from hard disk 136, loads the OS into memory, and jumps to an initial address provided by the operating system kernel. Typically, the operating system is loaded into random-access memory (RAM) within the data processing system. Once loaded and initialized, the operating system controls the execution of programs and may provide services such as resource allocation, scheduling, input/output control, and data management.

The present invention may be executed in a variety of data processing systems utilizing a number of different hardware configurations and software such as bootstrap programs and operating systems. The data processing system 100 may be, for example, a stand-alone system or part of a network such as a local-area network (LAN) or a wide-area network (WAN).

The preferred embodiment of the present invention, as described below, is implemented within a data processing system 100 with hardware multithreading (HMT). HMT allows two or more logical contexts, also referred to as logical processors, to exist on each processor. The processor management system implements one run queue for each logical processor. A run queue is a place where ready threads wait to run. When a processor becomes idle and there are no threads waiting in the run queue, the processor checks for threads to “steal” and run. This stealing process allows the system to balance utilization of the various run queues.

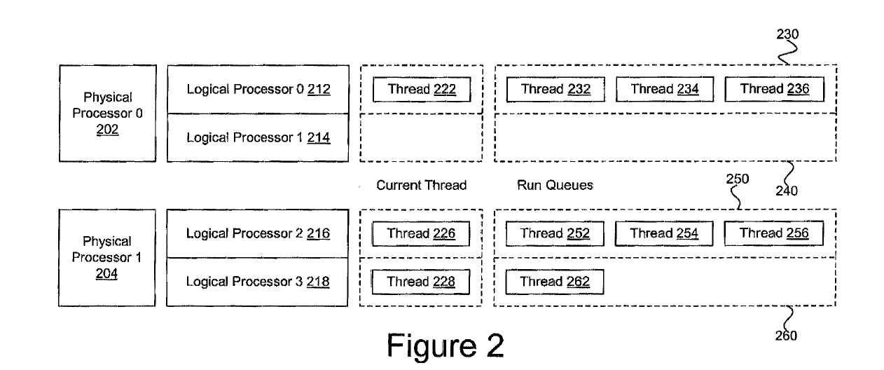

With reference to FIG. 2, a block diagram is shown illustrating hardware multithreading in a multiprocessing system in accordance with a preferred embodiment of the present invention. The multiprocessing system comprises physical processor 0 202 and physical processor 1 204. Physical processor 0 202 runs logical processor 0 212 and logical processor 1 214. Similarly, physical processor 1 204 runs logical processor 2 216 and logical processor 3 218. Logical processor 0 212 runs a current thread 222. Logical processor 1 214 is idle with no current thread running. Logical processor 2 216 runs thread 226 and logical processor 3 218 runs current thread 228.

The processor management system implements run queue 230 for logical processor 0, run queue 240 for logical processor 1, run queue 250 for logical processor 2, and run queue 260 for logical processor 3. Run queue 230 includes threads 232, 234, 236. Run queue 240 is empty. Run queue 250 includes threads 252, 254, 256. And, run queue 260 includes thread 262.

Since logical processor 1 214 has no current job (thread) running and the run queue is empty, logical processor 1 may steal a job from another logical processor. For example, logical processor 1 may steal thread 252 from logical processor 2. However, moving a thread between physical processors is expensive, particularly with respect to cache resources.

In accordance with a preferred embodiment of the present invention, a mechanism is invoked when run queue 240 is looking for a thread to dispatch and there is not a thread currently available. The mechanism checks to see if another logical processor on the same physical processor, i.e. logical processor 0 212, is running a thread. Since logical processor 0 212 is running thread 222, logical processor 1 214 reduces its priority, allowing logical processor 0 to consume all of the resources for physical processor 0 202. The hardware may have a “fairness” mechanisms to ensure that a low priority logical processor is not starved of CPU time forever. The hardware also contains a timer which will periodically wake up the low priority logical thread. Thus, when a thread becomes ready to dispatch, logical processor 1 can raise its priority and run a thread.

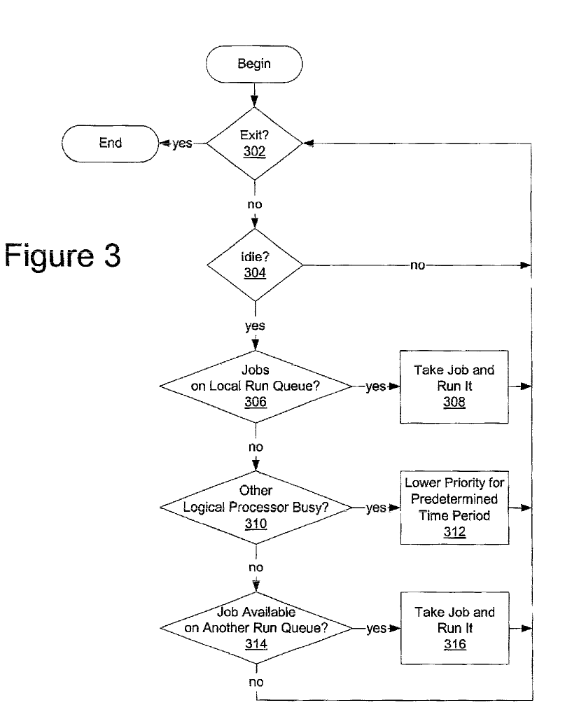

Turning now to FIG. 3, a flowchart is shown illustrating the operation of a logical processor in a multiprocessing system in accordance with a preferred embodiment of the present invention. The process begins and a determination is made as to whether an exit condition exists (step 302). An exit condition may be, for example, a shutdown of the system. If an exit condition exists, the process ends.

If an exit condition does not exist in step 302, a determination is made as to whether the logical processor is idle (step 304). If the logical processor is not idle, the process returns to step 302 to determine whether an exit condition exists. If the logical processor is idle in step 304, a determination is made as to whether a job exists in the local run queue (step 306). If a job exists in the local run queue, the process takes a job and runs it (step 308). Then, the process returns to step 302 to determine whether an exit condition exists.

If a job does not exist in the local run queue in step 306, a determination is made as to whether another logical processor on the same physical processor is busy (step 310). In other words, the process determines whether a current thread is running in another logical processor on the physical processor. If another logical processor on the same physical processor is busy, the logical processor lowers the priority for a predetermined time period (step 312) and the process returns to step 302 to determine whether an exit condition exists. By lowering the priority, the logical processor becomes dormant or “quiesces”. Another logical processor on the physical processor having a higher priority may then run on the physical processor and consume the resources, such as cache, of the physical processor.

If another logical processor is not busy on the same physical processor in step 310, a determination is made as to whether a job is available to run in another run queue (step 314). If a job is available to run in another run queue, the logical processor takes a job and runs it (step 316). If a job is not available to run in another run queue in step 314, the process returns to step 302 to determine whether an exit condition exists.

Thus, the present invention takes advantage of the fact that two or more logical processors exist on one physical processor. A mechanism is invoked when a run queue is looking for a thread to dispatch and there is not a thread currently available. The mechanism checks to see if another logical processor on the same physical processor is running a thread. If another logical processor on the same physical processor is running a thread, the logical processor reduces its priority, allowing the other active processor to consume all of the resources for the physical processor. The hardware contains a timer which will periodically wake up the low priority logical thread. Thus, when a thread becomes ready to dispatch, the logical processor can raise its priority and run a thread. The present invention allows the operating system to dynamically increase and decrease the active number of run queues on the hardware, thus improving the average processor dispatch affinity without changing the multiprogramming level.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing resources of a physical processor, comprising:
determining whether a first logical processor on the first physical processor is idle;
determining whether a second logical processor on the first physical processor is busy if the first logical processor is idle; and
relinquishing resources of the first physical processor to the second logical processor if the second logical processor is busy.

2. The method of claim 1, wherein the step of determining whether the first logical processor is idle comprises:
determining whether the first logical processor is running a current job; and
determining whether a first run queue corresponding to the first logical processor is empty if the first logical processor is not running a current job, wherein the first logical processor is idle if the first run queue is empty.

3. The method of claim 2, further comprising:
running a job from the first run queue on the first logical processor if the first run queue is not empty.

4. The method of claim 2, wherein the first logical processor is not idle if the first logical processor is running a current job.

5. The method of claim 1, further comprising:
determining whether a job is available in a second run queue corresponding to a third logical processor on a second physical processor if the second logical processor on the physical processor is not busy.

6. The method of claim 5, further comprising:
running a job from the second run queue on the first logical processor if a job is available in the second run queue.

7. The method of claim 1, wherein the second logical processor consumes resources of the first physical processor if the first logical processor has a lowered priority.

8. The method of claim 1, wherein the step of relinquishing the physical processor resources comprises:
lowering the priority of the first logical processor.

9. The method of claim 8, wherein the step of lowering the priority of the first logical processor comprises lowering the priority of the first logical processor for a predetermined time period.

10. The method of claim 9, further comprising raising the priority of the first logical processor after the predetermined period of time.

11. The method of claim 10, further comprising dispatching a job to the first logical processor in response to the raised priority.

12. An apparatus for controlling the active number of run queues on a first physical processor, comprising:
first determination means for determining whether a first logical processor on the first physical processor is idle;
first determination means for determining whether a second logical processor on the first physical processor is busy if the first logical processor is idle; and
relinquishing means for relinquishing resources of the first physical processor to the second logical processor if the second logical processor is busy.

13. The apparatus of claim 12, wherein the first determination means comprises:
means for determining whether the first logical processor is running a current job; and
means for determining whether a first run queue corresponding to the first logical processor is empty if the first logical processor is not running a current job, wherein the first logical processor is idle if the first run queue is empty.

14. The apparatus of claim 13, further comprising:
means for running a job from the first run queue on the first logical processor if the first run queue is not empty.

15. The apparatus of claim 13, wherein the first logical processor is not idle if the first logical processor is running a current job.

16. The apparatus of claim 12, further comprising:
means for determining whether a job is available in a second run queue corresponding to a third logical processor on a second physical processor if the second logical processor on the physical processor is not busy.

17. The apparatus of claim 16, further comprising:
means for running a job from the second run queue on the first logical processor if a job is available in the second run queue.

18. The apparatus of claim 12, wherein the second logical processor consumes the resources of the first physical processor if the first logical processor has a lowered priority.

19. The apparatus of claim 12 wherein the relinquishing means comprises:
priority means for lowering the priority of the first logical processor.

20. The apparatus of claim 19, wherein the priority means comprises means for lowering the priority of the first logical processor for a predetermined time period.

21. The apparatus of claim 20, further comprising means for raising the priority of the first logical processor after the predetermined period of time.

22. The apparatus of claim 21, further comprising means for dispatching a job to the first logical processor in response to the raised priority.

23. A computer program product, in a computer readable medium, for controlling the active number of run queues on a first physical processor, comprising:
instructions for determining whether a first logical processor on the first physical processor is idle;
instructions for determining whether a second logical processor on the first physical processor is busy if the first logical processor is idle; and
instructions for lowering the priority of the first logical processor if the second logical processor is busy.
